(19) United States
(12) Patent Application Publication
(10) Pub. No.: US 2011/0223282 A1
(43) Pub. Date: Sep. 15, 2011

(54) NUTRITIONAL COMPOSITION WITH ANTI-REGURGITATION PROPERTIES

(75) Inventors: Gabriela Bergonzelli Degonda, Bussigny (CH); Magali Faure, Mollie-margot (CH); Reinhold Fink, Oberdiessbach (CH); Clara Lucia Garcia-Rodenas, Forel (CH); Karl-Josef Huber-Haag, Pully (CH); Christoph Alexander Neumayer, Bern (CH)

(73) Assignee: NESTEC S.A., Vevey (CH)

(21) Appl. No.: 13/125,216

(22) PCT Filed: Oct. 16, 2009
(86) PCT No.: PCT/EP09/63612

§ 371 Date: Apr. 20, 2011

(30) Foreign Application Priority Data
Oct. 20, 2008 (EP) 08167053.1

(51) Int. Cl. A23C 9/20; A23L 1/305; A23C 21/00; A23L 1/0522

(52) U.S. Cl. 426/2; 426/648; 426/583; 426/580

(57) ABSTRACT

A nutritional composition for the management of regurgitation in infants which composition includes which composition includes a protein source consisting essentially of partially hydrolysed proteins, a lipid source and a carbohydrate source comprising a starch selected from cereal starch or potato starch wherein the starch amounts to between 18 to 25% of the nutritional composition on a dry weight basis.

This invention relates to a nutritional composition, more specifically to a nutritional composition designed to prevent or reduce regurgitation in infants suffering from post-prandial gastro-oesophageal reflux.

Post-prandial gastro-oesophageal reflux which is more commonly referred to as regurgitation or spitting-up is a common problem in infants up to the age of about six months. Typically, the infant will regurgitate some stomach contents after a feed, the amount varying from a teaspoonful to rather larger amounts in severe cases. The condition may have several different causes including a loose cardiac sphincter, an overly tight pyloric sphincter, air bubbles ingested with the feed or simply feeding too fast or too much. Generally, the condition resolves itself as the baby gets older without the need for medical intervention.

Mother's milk is recommended for all infants. However, in some cases breast feeding is inadequate or unsuccessful or inadvisable for medical reasons or the mother chooses not to breast feed either at all or for a period of more than a few weeks. Infant formulas have been developed for these situations.

As noted above, regurgitation generally diminishes as the baby gets older, usually ceasing altogether by 7 or 8 months of age. However, some mothers and other care-givers find the condition distressing and specialised anti-regurgitation formulas have been developed to try to alleviate it. For example, it has been proposed to add thickening agents such as rice cereal or carob bean or locust gums to regular infant formula to reduce the incidence and/or severity of regurgitation. These prior art approaches have various disadvantages. For example, the addition of rice cereal to infant formula renders the formula hyper-caloric thus exposing the infant to a risk of gaining weight too quickly. Approaches based on the use of gums have tended to suffer from the disadvantage that it is difficult to control the viscosity of the reconstituted formula.

More recently in EP 745330 it was proposed to manage regurgitation by feeding a formula thickened with a food starch such as potato starch or waxy grain starch. However, there remains a need for nutritional composition specifically designed to manage the problem of regurgitation in infants aged up to about eight months.

### SUMMARY OF THE INVENTION

The present inventors have realised that, in designing a nutritional composition for the management of regurgitation or spitting up in infants, it is advantageous to address the possible physiological cause of the problem at the same time as providing a thickened composition as advocated in the prior art.

Surprisingly, the inventors have observed that nutritional compositions containing partially hydrolyzed proteins can bind to the human CCK1 receptor and, by this mean, contribute to accelerate gastric emptying and to reduce regurgitation in infants.

Accordingly, the present invention provides a nutritional composition for the management of regurgitation in infants which composition includes a protein source consisting essentially of partially hydrolysed proteins, a lipid source and a carbohydrate source comprising a starch selected from cereal starch or potato starch wherein the starch amounts to between 18 to 25% of the nutritional composition on a dry weight basis.

The invention also extends to the use of a protein source consisting essentially of partially hydrolysed proteins, a lipid source and a carbohydrate source comprising from a starch selected from cereal starch or potato starch for the preparation of a nutritional composition for the management of regurgitation in infants wherein the starch amounts to between 18 to 25% of the nutritional composition on a dry weight basis.

The invention further extends to a method for the management of regurgitation in infants comprising feeding a therapeutic amount of a nutritional composition including a protein source consisting essentially of partially hydrolysed proteins, a lipid source and a carbohydrate source comprising a starch selected from cereal starch or potato starch wherein the starch amounts to between 18 to 25% of the nutritional composition on a dry weight basis to an infant in need thereof.

Colecystokinin (CCK) is a peptide hormone which is found both in the gastrointestinal tract throughout the human small intestine and nerves in the myenteric plexus of the enteric nervous system and in the central nervous system. CCK regulates the motor functions in the gastrointestinal tract and is responsible for a postprandial reduction in the cardiac sphincter pressure, an increase in the frequency of transient cardiac sphincter relaxations and an inhibition of gastric emptying. CCK1 receptor specifically mediates these CCK effects. Recent clinical studies show that pharmacological antagonist of CCK1 receptor accelerate gastric emptying and reduce the frequency of regurgitation in gastroesophageal reflux disease patients and have been suggested as an effective therapy for this condition (Peter SA, D'Amato M, Beglinger C., CCK1 antagonists: are they ready for clinical use? Dig Dis. 2006; 24(1-2):70-82.)

Without wishing to be bound by theory, the inventors believe that both frequent cardiac relaxations and increased pressure in the stomach after a meal are important factors contributing to the frequency and severity of regurgitation in infants who tend to suffer from this condition and that inhibition of CCK1 may decrease cardiac relaxation frequency and reduce the time take for the stomach to empty such as is provided by the use of partially hydrolysed proteins may significantly ameliorate these risk factors. At the same time, the use of a higher than usual proportion of starch in the composition provides both an increased viscosity compared with conventional infant formulas and an improved mouthfeel compared to unthickened infant formulas based on partially hydrolysed proteins.

As such the invention is believed to encompass effects extended beyond the mere thickening of the composition (that is conventionally believed to have a positive impact on regurgitation). It is further hypothesized that the thickening effect and the effect on receptors as explained above (“physiological effect”) synergize together to provide an improved anti-regurgitation benefit.

In one embodiment the invention relates to the use of a selected composition (of the invention) for the manufacture of a composition or of an infant formula in infants suffering from regurgitation.

In one embodiment the patient target group are infants between 0 and 4 months or between 0 and 6 months or between 4 and 12 months. In one embodiment the infants suffer from high frequency regurgitation and may be at risk of dehydration or malnutrition.

### DETAILED DESCRIPTION OF THE INVENTION

In this specification, the following expressions have the meanings assigned to them below:—

“protein source consisting essentially of partially hydrolysed proteins” means a source of amino nitrogen comprising a mixture of peptides of various sizes according to the degree of hydrolysis with a small quantity of free amino acids resulting from the hydrolysis process and containing no intact protein molecules;
“infant” means a child under the age of 12 months;
“management of regurgitation” means prevention of, or reduction in severity or frequency of, postprandial regurgitation.

All percentages and ratios are by weight unless otherwise specified.

A nutritional composition according to the present invention includes a protein source which consists essentially of partially hydrolysed proteins. The degree of hydrolysis of the proteins may be between 5 and 40% or between 5% and 50% but is more preferably between 15 and 25% or between 15% and 20%.

The energy density of a nutritional composition according to the invention is less than 680 kcal/1, preferably between 620 and 670 kcal/1. The protein source may be present in an amount of not more than 3 or no more than 2.7 g/100 kcal, preferably 1.7 to 2.6 or 1.7 to 2.1 g/100 kcal. Provided that the protein is partially hydrolysed, the type of protein is not believed to be critical to the present invention provided that the minimum requirements for essential amino acid content are met and satisfactory growth is ensured. Thus, protein sources including rice, casein and soy and mixtures thereof may be used although whey proteins are preferred either alone or mixed with casein proteins in a ratio between 60:40 and 70:30 whey:casein. The whey protein may be a whey protein isolate, acid whey, sweet whey or sweet whey from which the caseino-glycomacropeptide has been removed (modified sweet whey). Preferably, however, the whey protein is modified sweet whey. Sweet whey is a readily available by-product of cheese making and is frequently used in the manufacture of nutritional compositions based on cows' milk. However, sweet whey includes a component which is undesirably rich in threonine and poor in tryptophan called caseino-glycomacropeptide (CGMP). Removal of the CGMP from sweet whey results in a protein with a threonine content closer to that of human milk. A process for removing CGMP from sweet whey is described in EP 880902.

The protein source may additionally be supplemented with free amino acids if this is necessary to meet the minimum requirements for essential amino acid content. These requirements are published for example in EC Directive 2006/141/EC.

If modified sweet whey is used as the whey protein in a mixture of 60% whey and 40% casein, the protein source is preferably supplemented by free histidine in an amount of up to 0.19% of total protein content.

The protein source may be hydrolysed as desired and as is known in the art. For example, a whey protein hydrolysate may be prepared by enzymatically hydrolysing the whey fraction in one or more steps. If the whey fraction used as the starting material is substantially lactose free, it is found that the protein suffers much less lysine blockage during the hydrolysis process. This enables the extent of lysine blockage to be reduced from about 15% by weight of total lysine to less than about 10% by weight of lysine; for example about 7% by weight of lysine which greatly improves the nutritional quality of the protein source.

The nutritional composition of the present invention contains a source of carbohydrate comprising a starch selected from cereal starch or potato starch wherein the starch amounts to between 18 to 25% of the nutritional composition on a dry weight basis. Preferably the starch or starches comprise between 18 and 23% of the composition on a dry weight basis. Suitable cereal starches include corn starch and rice starch. Preferably, however, the starch is potato starch, more preferably pre-cooked potato starch. This is because unlike cereal starches, potato starch is commercially available in a form which is not contaminated with intact proteins. A suitable commercially available potato starch for use in the present invention is Quemina 21.216 Potato Starch sold by Agrana, A-1220 Vienna. The remainder of the carbohydrate source is preferably lactose although other carbohydrates such as saccharose and maltodextrin may also be added. Preferably, the carbohydrate content of the nutritional composition is between 9 and 14 g/100 kcal.

Preferably, the nutritional composition of the present invention is nutritionally complete, that is, it contains adequate nutrients to sustain healthy human life for extended periods. As such, the nutritional composition of the present invention preferably contains a source of lipids. The lipid source may be any lipid or fat which is suitable for use in nutritional compositions to be fed to infants. Preferred fat sources include coconut oil, low erucic rapeseed oil (canola oil), soy lecithin, palm olein, and sunflower oil. The essential polyunsaturated fatty acids linoleic acid and α-linolenic acid will also be added as may small amounts of oils containing high quantities of preformed long chain polyunsaturated fatty acids arachidonic acid and docosahexaenoic acid such as fish oils or single cell oils. In total, the lipid content may be between 4.4 and 6 g/100 kcal.

The nutritional composition may also contain all vitamins and minerals understood to be essential in the daily diet in nutritionally significant amounts. Minimum requirements have been established for certain vitamins and minerals. Examples of minerals, vitamins and other nutrients optionally present in the nutritional composition include vitamin A, vitamin B₁, vitamin B₂, vitamin B₆, vitamin B₁₂, vitamin E, vitamin K, vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, and L-carnitine. Minerals are usually added in salt form.

If necessary, the nutritional composition may contain emulsifiers and stabilisers such as soy lecithin, citric acid esters of mono- and di-glycerides, and the like. The nutritional composition may optionally contain other substances which may have a beneficial effect such as probiotic bacteria, fibres, nucleotides, nucleosides, and the like in the amounts customarily found in nutritional compositions to be fed to infants.

The nutritional composition may be prepared in any suitable manner. For example, a nutritional composition may be prepared by blending together the protein source, the carbohydrate source, and the lipid source in appropriate proportions. If used, emulsifiers may be included in the blend at this stage. The vitamins and minerals may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger.

The liquid mixture may then be cooled to about 60° C. to about 85° C.; for example by flash cooling. The liquid mixture may then be homogenised; for example in two stages at about 7 MPa to about 40 MPa in the first stage and about 2 MPa to about 14 MPa in the second stage. The homogenised mixture may then be further cooled and any heat sensitive components; such as vitamins and minerals may be added. The pH and solids content of the homogenised mixture is conveniently standardised at this point.

The homogenised mixture is transferred to a suitable drying apparatus such as a spray drier or freeze drier and converted to powder. The powder should have a moisture content of less than about 5% by weight.

A nutritional composition according to the invention may be fed to an infant suffering from regurgitation as the Sole source of nutrition until the age of four to six months and subsequently as part of a mixed diet during the introduction of solid foods as required to manage the regurgitation. In one embodiment the composition according to the invention is intended for infants between 0 and 4 weeks, between 0 and 2 months, between 0 and 4 months or between 0 and 6 months. In one embodiment the composition is intended for infants between 4 and 12 months, or between 6 and 24 months.

### Example 1

An example of a nutritional composition according to the present invention is given below.

| Nutrient | per 100 kcal | per litre |
|---|---|---|
| Energy (kcal) | 100 | 670 |
| Protein (g) | 1.90 | 12.8 |
| 100% hydrolysed whey protein | | |
| Degree of hydrolysis 18% | | |
| Fat (g) | 5.08 | 34.1 |
| Linoleic acid (g) | 0.78 | 5.2 |
| α-Linolenic acid (mg) | 94 | 630 |
| Carbohydrate (g) | 11.66 | 78.1 |
| of which: | | |
| Lactose | 7.63 | 51.1 |
| Potato starch | 4.03 | 27.0 |
| Minerals (g) | 0.41 | 2.8 |
| Na (mg) | 30 | 200 |
| K (mg) | 108 | 720 |
| Cl (mg) | 93 | 620 |
| Ca (mg) | 69 | 470 |
| P (mg) | 37 | 240 |
| Mg (mg) | 8.8 | 59 |
| Mn (μg) | 23 | 150 |
| Se (μg) | 1.8 | 12 |
| Vitamin A (μg RE) | 100 | 670 |
| Vitamin D (μg) | 1.3 | 8.8 |
| Vitamin E (mg TE) | 1.0 | 6.9 |
| Vitamin K1 (μg) | 8.6 | 58 |
| Vitamin C (mg) | 14 | 91 |
| Vitamin B1 (mg) | 0.098 | 0.66 |
| Vitamin B2 (mg) | 0.18 | 1.2 |
| Niacin (mg) | 1.0 | 6.9 |
| Vitamin B6 (mg) | 0.068 | 0.46 |
| Folic acid (μg) | 17 | 120 |
| Pantothenic acid (mg) | 1.0 | 6.9 |
| Vitamin B12 (μg) | 0.2 | 1.3 |
| Biotin (μg) | 2.5 | 17 |
| Choline (mg) | 10 | 69 |
| Fe (mg) | 1.1 | 7.3 |
| I (μg) | 14 | 96 |
| Cu (mg) | 0.074 | 0.5 |
| Zn (mg) | 0.74 | 4.9 |

### Example 2

An example of a nutritional composition (infant formula) according to the present invention is given below:

| Nutrient | per 100 kcal | per litre |
|---|---|---|
| Energy (kcal) | 100 | 670 |
| Protein (g) | 2.43 | 16.2 |
| 100% hydrolysed whey protein | | |
| Degree of hydrolysis 18% | | |
| Fat (g) | 4.65 | 31.05 |
| Linoleic acid (g) | 0.77 | 5.13 |
| α-Linolenic acid (mg) | 97 | 650 |
| Carbohydrate (g) | 12.11 | 80.9 |
| of which: | | |
| Lactose | 7.77 | 51.9 |
| Potato starch | 4.34 | 29 |
| Minerals (g) | 0.53 | 3.5 |
| Na (mg) | 47 | 310 |
| K (mg) | 117 | 780 |
| Cl (mg) | 99 | 660 |
| Ca (mg) | 115 | 770 |
| P (mg) | 72 | 480 |
| Mg (mg) | 8.5 | 57 |
| Mn (μg) | 16 | 110 |
| Se (μg) | 2.7 | 18 |
| Vitamin A (μg RE) | 110 | 730 |
| Vitamin D (μg) | 1.8 | 12 |
| Vitamin E (mg TE) | 0.87 | 5.8 |
| Vitamin K1 (μg) | 7.5 | 50 |
| Vitamin C (mg) | 20 | 140 |
| Vitamin B1 (mg) | 0.11 | 0.72 |
| Vitamin B2 (mg) | 0.26 | 1.8 |
| Niacin (mg) | 0.93 | 6.2 |
| Vitamin B6 (mg) | 0.07 | 0.49 |
| Folic acid (μg) | 19 | 130 |
| Pantothenic acid (mg) | 0.59 | 3.9 |
| Vitamin B12 (μg) | 0.2 | 1.4 |
| Biotin (μg) | 2.3 | 15 |
| Choline (mg) | 17 | 110 |
| Fe (mg) | 1.1 | 7.3 |
| I (μg) | 16 | 110 |
| Cu (mg) | 0.074 | 0.5 |
| Zn (mg) | 0.74 | 4.9 |

### Example 3

### In Vitro CCK1 Binding Assays

Three infant formulae (WPH1, WPH2 and RPH) were tested for their ability to inhibit the binding of a ligand to the human CCK1 receptor. WPH1 and WPH2 are commercial infant formulae based on and comprising whey protein hydrolysates. RPH is a commercial infant formula based on and comprising a rice protein hydrolysate. The formulae comprise starch between 18 and 25% (w/w of dry composition).

WPH1 contains 11.5% mildly hydrolyzed whey proteins at 18% hydrolysis degree; WPH2 contains 14.8% extensively hydrolyzed whey proteins at 42% hydrolysis degree; RPH contained 14% mildly hydrolyzed rice proteins at 21% hydrolysis degree.

The three formulas were tested at 13 mg/ml protein-equivalent concentration. Briefly, they were dissolved in an aqueous media and incubated for 60 min at 22° C. with human recombinant CHO cells transfected to express the CCK1 receptor on their membrane. The ability of the formulas to compete with, and inhibit the binding of a radioactive ligand ([¹²⁵I]CCK-8 s, 0.08 nM) to the human CCK1 receptor was measured by scintillation counting. A percentage of inhibition of binding was calculated. A high percentage of inhibition indicates a high binding activity of the formulas. Antagonists of the CKK receptors have been shown to accelerate gastric emptying and reduce the regurgitation episodes in patients. It is hypothesized that the formulae of the invention have a similar effect on the receptors and on the regurgitation/gastric emptying in general.

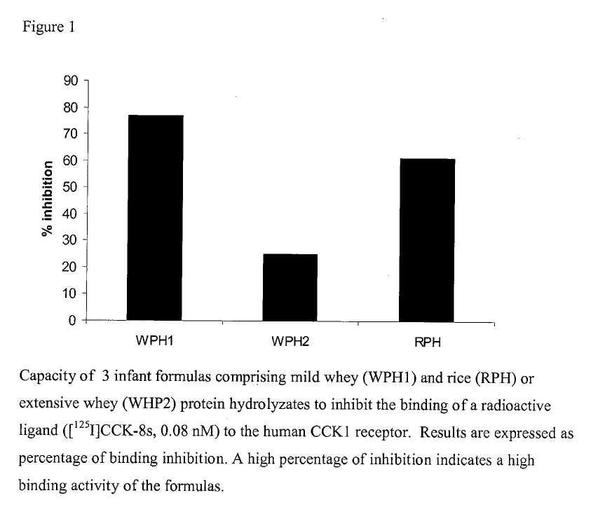

Results are displayed in FIG. 1. Both WPH1 and RPH2, containing mild hydrolyzate whey and rice protein respectively show a substantial binding activity to CCK1 receptor. In contrast, WPH2, containing extensively hydrolyzed whey protein, displayed a mild binding activity.

1. A nutritional composition for the management of regurgitation in infants which composition includes which composition includes a protein source consisting essentially of partially hydrolysed proteins, a lipid source and a carbohydrate source comprising a starch selected from cereal starch or potato starch wherein the starch amounts to between 18 to 25% of the nutritional composition on a dry weight basis.

2. A nutritional composition according to claim 1, wherein the degree of hydrolysis of the partially hydrolysed proteins is between 15 and 25%.

3. A nutritional composition according to claim 1 or 2, wherein the partially hydrolysed proteins are whey proteins.

4. A nutritional composition according to claim 1 or 2, wherein the partially hydrolysed proteins comprise rice proteins.

5. A nutritional composition as claimed in any preceding claim, wherein the starch comprises from 18 to 23% by weight of the nutritional composition.

6. A nutritional composition as claimed in any preceding claim, wherein the starch is potato starch.

7. A nutritional composition as claimed in any preceding claim wherein the remainder of the carbohydrate source is lactose.

8. Use of a protein source consisting essentially of partially hydrolysed proteins, a lipid source and a carbohydrate source comprising from a starch selected from cereal starch or potato starch for the preparation of a nutritional composition for the management of regurgitation in infants wherein the starch amounts to between 18 to 25% of the nutritional composition on a dry weight basis.

9. The use of claim 8, wherein the degree of hydrolysis of the partially hydrolysed proteins is between 15 and 25%.

10. The use of claim 8 or 9, wherein the partially hydrolysed proteins are whey proteins.

11. The use of claim 8 or 9, wherein the partially hydrolysed proteins comprise rice proteins.

12. The use of any of claims 8 to 11, wherein the starch comprises from 18 to 23% by weight of the nutritional composition.

13. The use of any of claims 8 to 12, wherein the starch is potato starch.

14. The use of any of claims 8 to 13, wherein the remainder of the carbohydrate source is lactose.
